(19) United States
(12) Patent Application Publication
(10) Pub. No.: US 2026/0312209 A1
(43) Pub. Date: Oct. 8, 2026

(54) BATTERY PACK

(71) Applicant: TOYOTA JIDOSHA KABUSHIKI KAISHA, Toyota-shi (JP)

(72) Inventor: Nobuyasu NISHIKI, Toyokawa-shi (JP)

(73) Assignee: TOYOTA JIDOSHA KABUSHIKI KAISHA, Toyota-shi (JP)

(21) Appl. No.: 19/637,506

(22) Filed: Apr. 2, 2026

(30) Foreign Application Priority Data
Apr. 8, 2025 (JP) 2025-063969

(51) Int. Cl. H01M 50/262; H01M 50/209; H01M 50/242; H01M 50/249; B60L 50/64

(52) U.S. Cl. CPC H01M 50/262; H01M 50/209; H01M 50/242; H01M 50/249; B60L 50/64; H01M 2220/20

(57) ABSTRACT

A battery pack includes: a lower case; a battery module including a plurality of stacked battery cells, the battery module being mounted on the lower case; a module mounting reinforcement fixed to the lower case; and an L-shaped bracket, one surface of which is fixed to an end of the battery module and an other surface of which is fixed to the module mounting reinforcement.

The present application claims priority to and incorporates by reference the entire contents of Japanese Patent Application No. 2025-063969 filed in Japan on Apr 8, 2025.

### BACKGROUND

The present disclosure relates to a battery pack.

JP2018181748A discloses a battery pack including a lower case that supports a battery module in a mounted state, a cover attachable to the lower case, and a fastening bar that contacts the battery module collectively via fixing pieces on the lower case.

### SUMMARY

In the battery pack disclosed in JP2018181748A, since the battery module is directly fixed to the lower case, there is a risk that the lower case may be damaged at the fixing portion due to expansion pressure if the battery cells constituting the battery module expand.

There is a need for a battery pack that may suppress damage to the lower case even if the battery cells expand.

According to one aspect of the present disclosure, there is provided a battery pack including: a lower case; a battery module including a plurality of stacked battery cells, the battery module being mounted on the lower case; a module mounting reinforcement fixed to the lower case; and an L-shaped bracket, one surface of which is fixed to an end of the battery module and an other surface of which is fixed to the module mounting reinforcement.

### BRIEF DESCRIPTION OF THE DRAWINGS

FIG. 1 is an example diagram showing a key portion of the battery pack according to an embodiment;

FIG. 2 is an oblique view showing the general configuration of the bracket;

FIG. 3 is a sectional view along line A-A in FIG. 1;

FIG. 4 is an explanatory view when the battery case receives a lateral impact load;

FIG. 5 is a view showing the bracket directly attached to the lower case;

FIG. 6 is an example of a battery case where the lower case and the reinforcement ring are integrally formed; and

FIG. 7 is another example of a battery case where the lower case and the reinforcement ring are integrally formed.

### DETAILED DESCRIPTION

The following describes an embodiment of the battery pack according to the disclosure. Note that the disclosure is not limited to these embodiments.

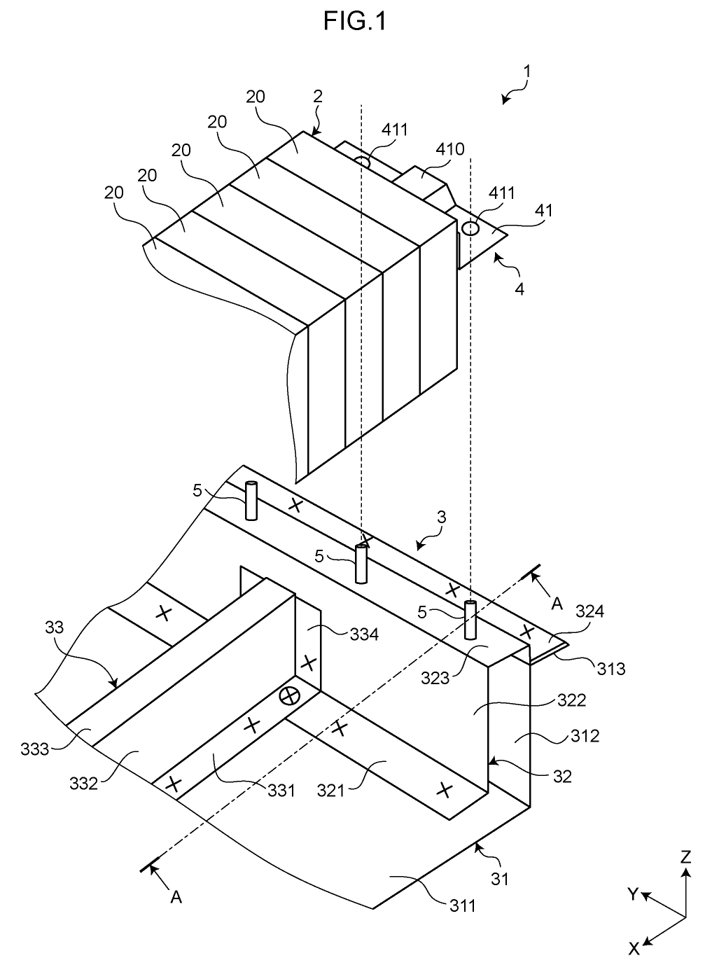

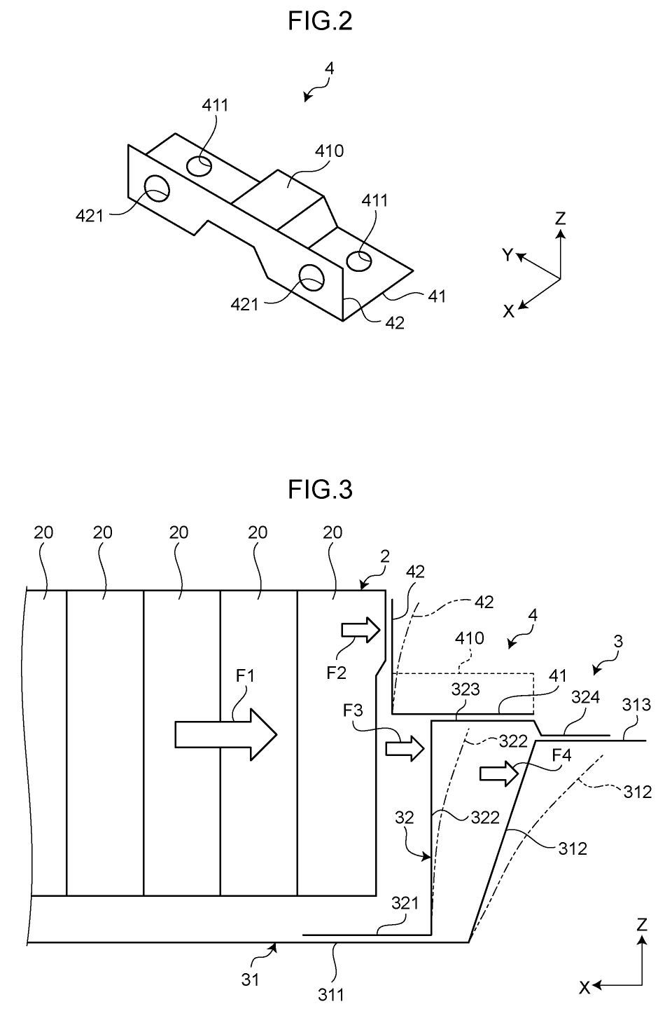

FIG. 1 is an example showing a key part of the battery pack 1 according to an embodiment. FIG. 2 is an isometric view showing the general configuration of the bracket 4.

The battery pack 1 according to the embodiment has a structure, as shown in FIG. 1, wherein a battery module 2, formed by stacking a plurality of battery cells 20, is housed in a lower case 31. This lower case 31, together with an upper case (not shown), forms the battery case 3. The battery pack 1 according to the embodiment is mounted, for example, on a vehicle equipped with at least a motor as a drive source. In this embodiment, the Width direction X of the battery pack 1 is also referred to simply as “Width direction X”. Furthermore, in this embodiment, the front-rear direction Y, which is orthogonal to the Width direction X of the battery pack 1, is also referred to simply as “front-rear direction Y”. In this embodiment, the height direction Z, which is perpendicular to both the Width direction X and the front-rear direction Y of the battery pack 1, is also simply referred to as the “height direction Z”. Furthermore, the Width direction X, front-rear direction Y, and height direction Z of the battery pack 1 correspond to the same directions as the Width direction, front-rear direction, and height direction of the vehicle in which the battery pack 1 is installed.

The lower case 31 has a module mounting reinforcement 32 and a reinforcement (module-to-module reinforcement) 33 joined thereto, for example, by welding.

The lower case 31 includes a bottom plate portion 311, a side plate portion 312, and a flange portion 313, forming a box-shaped structure open at the top. The lower case 31 is constructed, for example, from metallic materials such as iron or aluminum. The bottom plate portion 311 is positioned beneath the battery module 2. The side plate portion 312 extends upward from the periphery of the bottom plate portion 311 and surrounds the battery module 2. The flange portion 313 constitutes the peripheral edge of the lower case 31 and projects outward in the Width direction X from the upper edge of the side plate portion 312.

The module mounting reinforcement 32 includes a bottom plate section 321, a side plate section 322, a bracket mounting surface section 323, and a flange mounting surface section 324. The side plate portion 322 rises from the outer end of the bottom plate portion 321 in the width direction X. The bracket mounting surface portion 323 extends outward in the width direction X from the upper end of the side plate portion 322. Furthermore, the flange mounting surface portion 324 extends outward in the width direction X, bending from the outer end of the bracket mounting surface portion 323 in the width direction X. The bottom plate portion 321 of the module mounting reinforcement 32 is joined to the bottom plate portion 311 of the lower case 31 by welding or the like. Furthermore, the flange mounting surface portion 324 of the module mounting reinforcement 32 is joined to the flange portion 313 of the lower case 31 by welding or the like. The × marks and × marks enclosed by circles in FIG. 1 indicate joints (connection points) formed by welding or similar methods.

The reinforcement rib 33 includes a bottom plate portion 331, a side plate portion 332, a top plate portion 333, and an end face portion 334. The side plate portion 332 rises from the inner end of the bottom plate portion 331 in the front-rear direction Y, and the top plate portion 333 extends inward in the front-rear direction Y from the upper end of the side plate portion 332. Furthermore, the reinforcement rib 33 has a bottom wall section and a side wall section, similar to the bottom plate section 331 and the side plate section 332, on the opposite side from the top plate section 333, spanning the top plate section 333. The end face portion 334 is a flat plate extending in the front-rear direction Y and the height direction Z. It is provided at the end of the reinforcement rib 33 in the Width direction X and is connected to the bottom plate portion 331, the side plate portion 332, and the top plate portion 333. The bottom plate portion 331 of the reinforcement rib 33 is joined, for example by welding, to the bottom plate portion 311 of the lower case 31, except for the end portion in the Width direction X. Furthermore, the end of the width direction X of the bottom plate portion 331 of the reinforcement rib 33 is joined by welding or the like to both the bottom plate portion 311 of the lower case 31 and the bottom plate portion 321 of the module mounting rib 32. Furthermore, the end surface portion 334 of the reinforcement rib 33 is joined to the side plate portion 322 of the module mounting rib 32 by welding or the like.

A bracket 4 is fixed and provided at the end portion in the Width direction X of the battery module 2 by fastening members such as bolts. As shown in FIG. 2, bracket 4 has an L-shape. One mounting surface portion 42 is fixed to the end of battery module 2 by fasteners, and the other mounting surface portion 41 is fixed to bracket mounting surface portion 323 of module mounting reinforcement 32 by fasteners. When fixing the mounting surface portion 42 to the end of the battery module 2, for example, a bolt is inserted through a through hole 421 provided in the mounting surface portion 42 and tightened into a female threaded portion (not shown) provided at the end of the battery module 2. To secure the other mounting surface 41 to the bracket mounting surface 323, for example, a male threaded portion 5 extending in the height direction Z from the bracket mounting surface 323 is inserted through a through hole 411 provided in the other mounting surface 41 and tightened with an unillustrated nut.

The other mounting surface 41 of the bracket 4 has a convex-shaped reinforcement bead 410 provided centrally in the front-rear direction Y. On the other hand, the one mounting surface 42 of the bracket 4 is formed as a flat plate shape, having lower rigidity than the other mounting surface 41.

The bracket 4 fixed to the end of the battery module 2 is attached to the bracket mounting surface 323 of the module mounting reinforcement 32 joined to the lower case 31. This bracket mounting surface 323 is positioned higher than the bottom plate portion 311 of the lower case 31. For example, as shown in FIG. 1, the bracket mounting surface 323 of the module mounting reinforcement 32 is positioned higher than the flange portion 313 of the lower case 31. A reinforcement rib (module-to-module rib) 33 is provided between battery modules 2. The reinforcement rib 33 is welded to the side plate portion 322 of the module mounting rib 32 at its lowest end on the longitudinal end face portion 334. FIG. 3 is a sectional view along line A-A in FIG. 1. Note that in FIG. 3, gaps are shown between the battery module 2, lower case 31, module mounting reinforcement 32, reinforcement 33, and bracket 4. This is for clarity and ease of explanation; unless specifically noted, they are actually in contact with each other. The same applies to other drawings used in the following description.

The expansion load (expansion pressure) F1 when the battery cell 20 of the battery module 2 expands due to aging is a large load of several tons. However, the expansion amount of the battery module 2 (battery cell 20) is small, on the order of several [mm]. Therefore, in the battery pack 1 according to the embodiment, by reducing the rigidity of one mounting surface portion 42 of the bracket 4, that mounting surface portion 42 may deform under low load. Consequently, when the bracket 4 receives a load F2, which is part of the expansion load F1 from the battery module 2, the one mounting surface portion 42 may deform under a low load. This reduces the stress generated on the one mounting surface portion 42 of the bracket 4.

The battery pack 1 according to the embodiment may absorb the expansion amount by receiving the expansion load (expansion pressure) at one mounting surface portion 42 of bracket 4, even if battery cell 20 of battery module 2 expands due to aging, thereby suppressing case damage.

Furthermore, in the battery pack 1 according to the embodiment, rigidity is ensured by the reinforcement bead 410 provided on the other mounting surface portion 41 of the bracket 4. This suppresses vertical vibrations that may occur during vehicle travel on rough or undulating roads. The other mounting surface portion 41 of bracket 4 is attached to the bracket mounting surface portion 323 of module mounting reinforcement 32, which is positioned higher in the height direction Z than the bottom plate portion 311 of lower case 31. The deflection amount of the side plate section 332 of the module mounting reinforcement 32 is determined proportionally to the cube of the height in the Z-direction from the lower end to the upper end of the side plate section 332. Therefore, when a load F3 is applied to the side plate portion 322 via the bracket mounting surface 323 from the bracket 4 due to expansion of the battery module 2 (battery cell 20), the side plate portion 322 may deform under low load. This reduces the stress generated in the side plate portion 322.

Furthermore, the flange mounting surface portion 324 of the module mounting reinforcement 32 is attached to the flange portion 313 of the lower case 31, which is positioned higher in the height direction Z than the bottom plate portion 311 of the lower case 31. The deflection amount of the side plate section 312 is determined proportionally to the cube of the height in the Z-direction from the lower end to the upper end of the side plate section 312 in the lower case 31. Therefore, when a load F4 is applied to the side plate portion 312 via the flange portion 313 from the flange mounting surface portion 324 due to expansion of the battery module 2 (battery cell 20), the side plate portion 312 may deform under low load. This reduces the stress generated in the side plate portion 312.

As described above, when the battery cell 20 of the battery module 2 expands due to aging, the mounting surface portion 42 of one side of the bracket 4, the side plate portion 322 of the module mounting reinforcement 32, and the side plate portion 312 of the lower case 31 may easily deform within their elastic range. This allows the mounting surface portion 42 of the bracket 4, the side plate portion 322 of the module mounting reinforcement 32, and the side plate portion 312 of the lower case 31 to absorb the expansion amount of the battery module 2 (battery cell 20), thereby suppressing damage to the lower case 31. Furthermore, during deformation of the side plate portion 322 of the module mounting reinforcement 32, stress increases at the joint (connection point) with the side plate portion 322. Therefore, positioning the joint (connection point) between the end surface portion 334 of the reinforcement rib 33 and the side plate portion 322 of the module mounting rib 32 at the lowest point in the height direction Z reduces the stress generated at said joint (connection point) during deformation of the side plate portion 322.

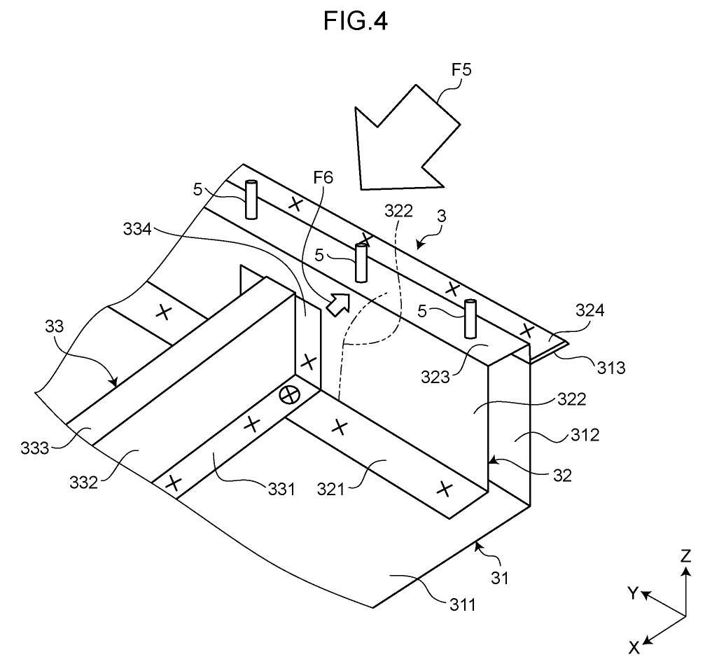

When deformation of only one mounting surface portion 42 of bracket 4 may absorb the expansion amount of battery module 2 (battery cell 20), the rigidity of side plate portion 312 in lower case 31 may be high. Furthermore, when deformation of the side plate portion 312 in the lower case 31 alone may absorb the expansion amount of the battery module 2 (battery cell 20), the rigidity of one mounting surface portion 42 in the bracket 4 may be high. FIG. 4 is an explanatory diagram showing the battery case 3 subjected to a lateral impact load.

As shown in FIG. 4, when the battery case 3 (lower case 31) receives a lateral impact load F5 from the Width direction X, the entire side plate portion 322 of the module mounting reinforcement 32 is pressed. Therefore, regardless of the position in the height direction Z of the joint (joint point) between the side plate portion 322 of the module mounting reinforcement 32 and the end face portion 334 of the reinforcing reinforcement 33, the reinforcing reinforcement 33 (end face portion 334) may ensure a holding load F6 that holds down the side plate portion 322 against the lateral impact load F5.

Furthermore, the position of the joint (joint point) between the side plate portion 322 of the module mounting reinforcement 32 and the end face portion 334 of the reinforcement 33 is set at the lowest point in the height direction Z on the end face portion 334 of the reinforcement 33. This ensures the joint (joint point) is formed at a location where the deflection deformation of the side plate portion 322 due to the bracket 4 tipping inward is minimal. Consequently, the stress attempting to peel the side plate portion 322 away from the end face portion 334 (peel stress) may be reduced.

Furthermore, the side plate portion 322 of the module mounting reinforcement 32 and the end face portion 334 of the reinforcement 33 need not be joined by welding or similar means. For example, the side plate portion 322 of the module mounting reinforcement 32 and the end face portion 334 of the reinforcement 33 may simply be brought into abutment without being joined by welding or similar means. Furthermore, a minimal gap to prevent noise may be provided between the side plate portion 322 of the module mounting reinforcement 32 and the end face portion 334 of the reinforcement 33.

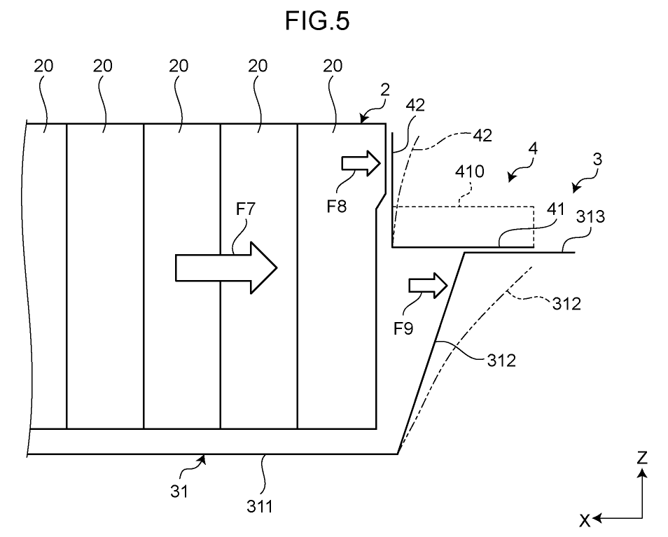

FIG. 5 illustrates an example where the bracket 4 is directly attached to the lower case 31.

In the battery pack 1 according to the embodiment, the module mounting reinforcement 32 may be omitted, and the other mounting surface portion 41 of the bracket 4 may be directly attached to the flange portion 313 of the lower case 31, as shown in FIG. 5.

This allows the mounting surface portion 42 of bracket 4 to deform and absorb the expansion when battery cell 20 of battery module 2 expands and bracket 4 receives load F8, which is part of the expansion load F7 from battery module 2.

Furthermore, in the battery pack 1 according to the embodiment, the other mounting surface portion 41 of the bracket 4 is attached to the flange portion 313 of the lower case 31, which is positioned higher in the height direction Z than the bottom plate portion 311 of the lower case 31. Consequently, when load F9 is applied to the side plate portion 312 of the lower case 31 via the flange portion 313 from the other mounting surface portion 41, the side plate portion 312 may deform under a low load. This reduces the stress generated in the side plate portion 312.

As described above, even when bracket 4 is directly attached to lower case 31, the expansion of battery module 2 (battery cell 20) may be absorbed by one mounting surface 42 of bracket 4 and side plate portion 312 of lower case 31, thereby suppressing damage to lower case 31.

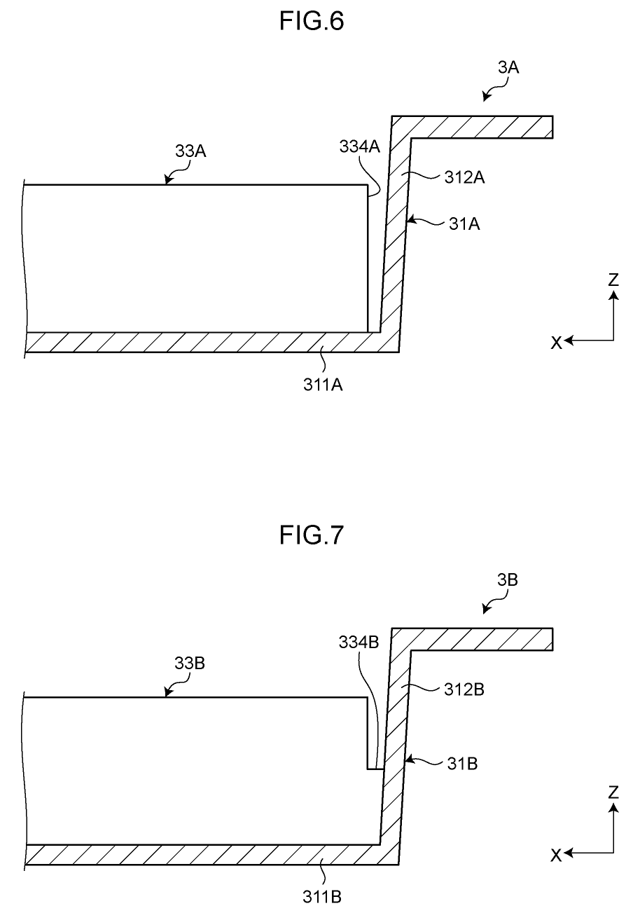

FIG. 6 illustrates an example of a battery case where the lower case and the reinforcement rib are integrally formed.

In the battery case 3A shown in FIG. 6, the lower case 31A and the reinforcement rib 33A are integrally molded, for example by die casting, to form an integrated structure. Furthermore, in the battery case 3A shown in FIG. 6, by positioning the end portion 334A of the reinforcing rib 33A in the Width direction X up to the front of the side plate portion 312A of the lower case 31A, it becomes possible to avoid the effects of the side plate portion 312A collapsing inward. FIG. 7 illustrates another example of a battery case where the lower case and the reinforcing rib are integrally formed.

In the battery case 3B shown in FIG. 7, the lower case 31B and the reinforcing rib 33B are integrally molded using a process such as die casting. Furthermore, in the battery case 3B shown in FIG. 7, by limiting the connection portion between the end 334B of the reinforcing rib 33B and the side plate portion 312B of the lower case 31B to only the lower half in the height direction Z, it becomes possible to avoid the effects of the side plate portion 312B collapsing. The battery pack of the present disclosure achieves the effect of suppressing damage to the lower case. This is because, even if the battery cells in the battery module expand, the bracket and the module mounting rib may absorb the expansion amount by receiving the expansion load.

Furthermore, by providing a convex-shaped reinforcement bead on the other surface of the bracket, the rigidity against vertical vibration of the bracket may be increased.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack comprising:
a lower case;
a battery module including a plurality of stacked battery cells, the battery module being mounted on the lower case;
a module mounting reinforcement fixed to the lower case; and
an L-shaped bracket, one surface of which is fixed to an end of the battery module and an other surface of which is fixed to the module mounting reinforcement.

2. The battery pack according to claim 1, further comprising a convex-shaped reinforcing bead on the other surface of the L-shaped bracket.
